(19) United States
(12) Patent Application Publication
(10) Pub. No.: US 2005/0256728 A1
(43) Pub. Date: Nov. 17, 2005

(54) Authorization control system and method thereof

(76) Inventor: Yi-Shiuan Huang, Jhubei City (TW)

Correspondence Address: THOMAS, KAYDEN, HOSTEMEYER & RISLEY LLP, 100 GALLERIA PARKWAY, SUITE 1750, ATLANTA, GA, 30339, US

(21) Appl. No.: 10/847,019

(22) Filed: May 17, 2004

(51) Int. Cl. G06F 17/60

(52) U.S. Cl. 705/1

(57) ABSTRACT

A system and method for authorization control including a storage device and an authorization module. The storage device stores multiple study requirement records and study history records. The authorization module receives an authorization request with a check item ID and an operator ID, acquires a first document ID set corresponding to the check item ID by querying the study requirement records, acquires a second document ID set corresponding to the operator ID by querying the study history records, and returns a rejection message when the first document ID set is not subset of the second document ID set.

### BACKGROUND

The present invention relates to security control technology, and more particularly, to a method and system of authorization control.

A conventional semiconductor factory typically includes the requisite fabrication tools to process semiconductor wafers for a particular purpose, such as photolithography, chemical-mechanical polishing, or chemical vapor deposition. During manufacturing, the semiconductor wafer passes through a series of process steps, which are performed by various fabrication tools. For example, in the production of an integrated semiconductor product, the semiconductor wafer passes through up to 600 process steps.

The costs for such automated production are influenced to a great extent by the question as to how well and efficiently the manufacturing process can be monitored or controlled, so that the ratio of defect-free products to the overall number of products manufactured (i.e., yield ratio) achieves as great a value as possible. Unfortunately, the individual process steps are subject to fluctuations and irregularities, which in the worst case may mean, for example, defects in a number of chips or the entire wafer. Therefore, each individual process step must be carried out as stably as possible in order to ensure an acceptable yield after the completed processing of a wafer.

Numerous documents, such as tool guides, tool handbooks, troubleshooting instruction guides, and the like, contain significant and relevant information associated with a fabrication tool. In order to ensure acceptable yield, an operator must read sufficient documentation to acquire necessary knowledge before operating a fabrication tool. Unfortunately, automatic detection of sufficient knowledge is unavailable.

In view of these limitations, a need exists for a system and method of authorization control that effectively detects that significant and sufficient documents have been read or fully understood before operating a fabrication tool, thus, ensuring acceptable yield.

### SUMMARY

It is therefore an object of the present invention to provide a system and method of authorization control that effectively detects that significant and sufficient documents have been read or fully understood before operating a fabrication tool, thus, ensuring acceptable yield.

According to an embodiment of the invention, the system includes an authorization control apparatus, a fabrication tool and a computer integrated manufacturing (CIM) system.

The fabrication tool typically performs a single wafer fabrication operation upon wafers in a given lot. The wafer fabrication operation is performed according to a predefined procedure (i.e., a predetermined set of steps or “recipe”). An equipment automation program (EAP) is embedded in a host computer for transferring messages and issues a command between the CIM system and the fabrication tool.

The CIM system connects to the host computer and the host computer connects to the fabrication tool. In order to ensure an operator has requisite knowledge to operate the fabrication tool, an authorization procedure is provided. After receiving an operation request with an operator identity, i.e., a user account, a tool identity and relevant recipes, the CIM system sends an authorization request with the operator identity and the tool identity to the authorization control apparatus and waits a result message indicating the authorization is permitted or prohibited. If an acceptance message is received, an operation command with relevant recipes can be subsequently transferred to the fabrication tool; otherwise, an authorization fail message is displayed.

The authorization control apparatus includes a central processing unit (CPU), a memory, a storage device, an input device, a display device and a communication device. The CPU, controlled by instructions received from the memory and from an operator through the input device, executes authorization control functions.

The storage device stores multiple study requirement records and study history records. The study requirement record is capable of storing check item information, such as fabrication tool, CIM function or entrance, with required documents, and preferably includes two fields, a check item identity and a document identity. The study history record is capable of storing information regarding documents studied by an operator, and preferably includes two fields, an operator identity and a document identity.

The memory preferably includes a requirement configuration module, a study history creation module and an authorization module, which include routines for performing authorization control functions.

The requirement configuration module provides a graphical user interface (GUI) to facilitate the generation of the study requirement record, such as inserting a record, deleting a record, and modifying a specific value of a record.

The study history creation module provides a graphical user interface (GUI) to facilitate selection and display of a document. The study history creation module inserts a new study history record specifying which document has been read. Alternatively, the study history creation module can provide an exam, preferably containing more than ten questions, corresponding to a document through the GUI and determine whether the exam is passed or failed. The study history creation module inserts a new study history record containing the document and the operator identity once the exam is passed.

The authorization module receives an authorization request with a check item identity, such as a fabrication tool identity, a function identity, an entrance identity or others, and an operator identity. A required document set containing multiple document identities is acquired from the study requirement records for the given check item identity, and a studied document set is acquired from the study history records for the given operator identity. The authorization module determines whether the request is authorized by comparing the requirement and the studied document set. If all document identities in the required document set are fully included in the studied document set, the authorization module returns an acceptance message; otherwise, it returns a rejection message.

### BRIEF DESCRIPTION OF THE DRAWINGS

The aforementioned objects, features and advantages of this invention will become apparent by referring to the following detailed description of the preferred embodiment with reference to the accompanying drawings, wherein:

FIG. 1 is a diagram of the architecture of the system for authorization control according to the present invention;

FIG. 2 is a diagram of the architecture of the authorization control apparatus according to the present invention;

FIG. 3 is a flowchart showing the method of authorization control according to the present invention;

FIG. 4 is a diagram of a storage medium for storing a computer program providing the method of authorization control according to the invention.

### DESCRIPTION

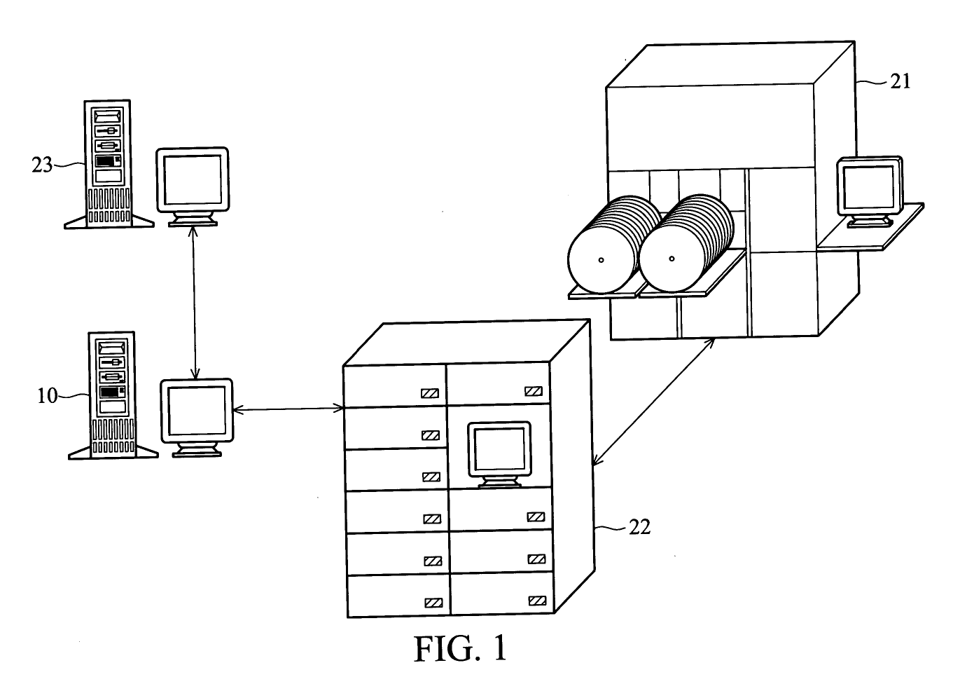

FIG. 1 is a diagram of the architecture of the system for authorization control according to the present invention. According to an embodiment of the invention, the system includes an authorization control apparatus 10, a fabrication tool 21, a computer integrated manufacturing (CIM) system 22 and an entrance control system 23.

The fabrication tool 21 typically performs a single wafer fabrication operation upon the wafers in a given lot. For example, a particular fabrication tool may perform a layering operation, a patterning operation, a doping operation or a heat treatment upon the wafers. The wafer fabrication operation is performed according to a predefined procedure (i.e., a predetermined set of steps or “recipe”). An equipment automation program (EAP) is embedded in a host computer (not shown) for transferring messages and issuing commands between the CIM system 22 and the fabrication tool 21.

The CIM system 22 connects to the host computer (not shown) and the host computer connects to the fabrication tool 21. In order to ensure an operator has requisite knowledge to operate the fabrication tool 21, an authorization procedure is provided. After receiving an operation request with an operator identity, i.e., a user account, a tool identity and relevant recipes, the CIM system 22 sends an authorization request with the operator identity and the tool identity to the authorization control apparatus 10 and waits for a result message indicating if authorization is permitted or prohibited. If an acceptance message is received, an operation command with relevant recipes can be subsequently issued to the fabrication tool 21; otherwise, an authorization fail message is displayed.

The CIM system 22 additionally provides various functions, such as production planning, scheduling and the like for semiconductor manufacturing. In order to ensure an operator has requisite knowledge to operate CIM functions, a similar authorization procedure is provided. After receiving an execution command with an operator identity, a function identity and relevant parameter values, the CIM system 22 sends an authorization request with the operator identity and the function identity to the authorization control apparatus 10 and waits a result message indicating that the authorization is permitted or prohibited. If an acceptance message is received, the CIM system 22 executes the command with the parameter values; otherwise, an authorization fail message is displayed.

The entrance control system 23 connects to and controls a door to ensure the security of an office, a semiconductor factory, a cleaning room or others, by providing an operator security check. In order to ensure an operator has requisite knowledge, such as public safety disciplines, an authorization procedure is employed. After receiving an entrance request with an operator identity and an entrance identity corresponding to the door, the entrance control system 23 sends an authorization request with the operator identity and the entrance identity to the authorization control apparatus 10 and waits for a result message indicating whether the authorization is permitted or prohibited. If an acceptance message is received, the door is opened by the entrance control system 23; otherwise, an authorization fail alarm is sounded.

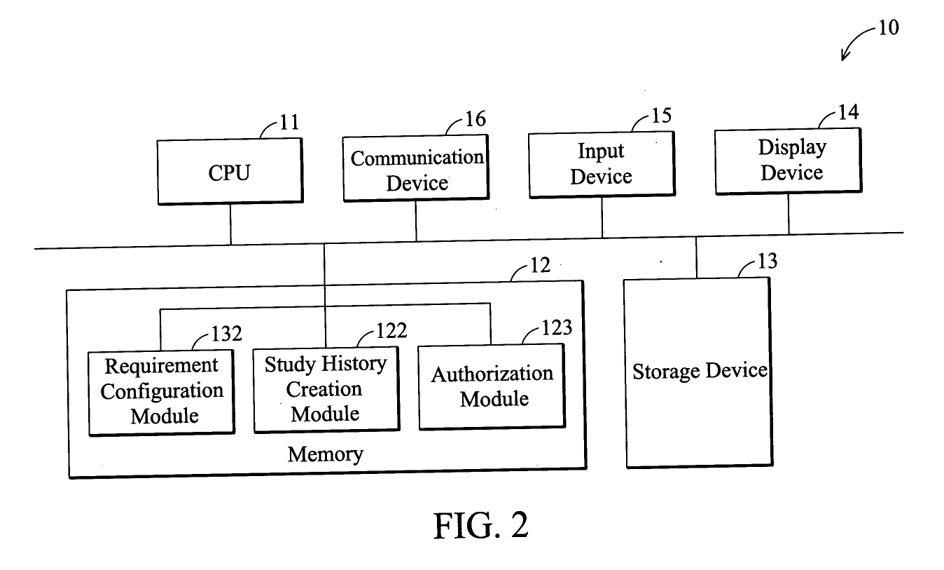

FIG. 2 is a diagram of the architecture of the authorization control apparatus according to the present invention. The authorization control apparatus 10 includes a central processing unit (CPU) 11, a memory 12, a storage device 13, an input device 14, a display device 15 and a communication device 16. The CPU 11 is connected by buses 17 to the memory 12, storage device 13, input device 14, display device 15 and communication device 16 based on Von Neumann architecture. The CPU 11, memory 12, storage device 13, display device 14, input device 15 and communication device 16 may be conventionally coupled to a mainframe computer, a mini-computer, a workstation computer, a personal computer, or a mobile computer.

The CPU 11, controlled by instructions received from the memory 12 and from an operator through the input device 14, executes authorization control functions.

The storage device 13 can be implemented as a database system, a file, or the like, to store multiple study requirement records and study history records. The study requirement record is capable of storing check item information, such as fabrication tool, CIM function or entrance, with required documents, and preferably includes two fields, a check item identity and a document identity. The study history record is capable of storing information regarding documents studied by an operator, and preferably includes two fields, an operator identity and a document identity. Consistent with the scope and spirit of the invention, additional or different fields may be provided.

The memory 12 is preferably a random access memory (RAM), but may also include read-only memory (ROM) or flash ROM. The memory 12 preferably includes a requirement configuration module 121, a study history creation module 122 and an authorization module 123, which include routines for performing authorization control functions.

The requirement configuration module 121 provides a graphical user interface (GUI) to facilitate the generation of the study requirement record, such as inserting a record, deleting a record, modifying a specific value of a record. Documents corresponding to a checked item are specified via the GUI. The GUI can also provide additional responses to information requests as required. The requirement configuration module 121 takes corresponding actions, such as sending a SQL command to a database system or modifying specific data in a file, corresponding to manipulation via the GUI.

The study history creation module 122 provides a GUI to select and display a document. The study history creation module 122 inserts a new study history record specifying which document is read. Alternatively, the study history creation module 122 can provide an exam, preferably containing more than ten questions, corresponding to a document through the GUI and determine whether the exam is passed or failed. The study history creation module 122 inserts a new study history record containing the document and the operator identity once the exam is passed.

The authorization module 123 receives an authorization request with a check item identity, such as a fabrication tool identity, a function identity, an entrance identity or others, and an operator identity. A required document set containing multiple document identities is acquired from the study requirement records for the given check item identity, and a studied document set is acquired from the study history records for the given operator identity. The authorization module 123 determines whether the request is authorized by comparing the requirement and the studied document set. If all document identities in the required document set are fully included in the studied document set, the authorization module 123 returns an acceptance message; otherwise, it returns a rejection message.

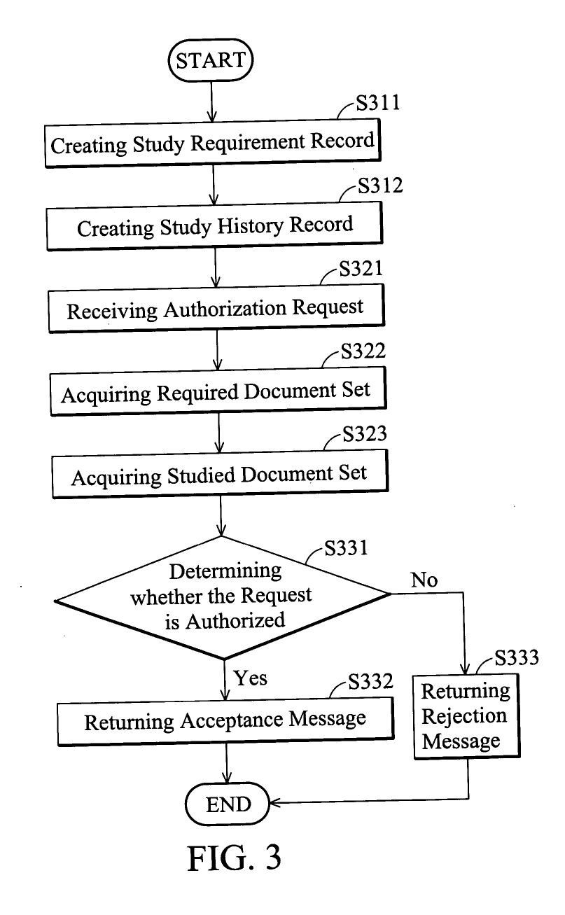

FIG. 3 is a flowchart showing the method of authorization control according to the present invention. The method begins in step S311 by creating study requirement records. The study requirement record is capable of storing check item information and corresponding study documents, and preferably includes two fields, a check item identity and a document identity. In step S312, study history records are created when a document is read or an exam corresponding to a document is completed and passed by an operator.

Subsequent to creation, the process proceeds to step S321 to receive an authorization request with a check item identity, such as a fabrication tool identity, a function identity, an entrance identity or others, and an operator identity from the CIM system 22 or the entrance control system 23. In step S322, the required document set containing multiple document identities corresponding to the check item identity is acquired from the study requirement records. In step S323, the studied document set containing multiple document identities corresponding to the operator identity is acquired from the study history records. Whether the request is authorized is determined in step S331 by comparing the required document set and the studied document set. If all document identities in the required document set are fully included in the studied document set, the process proceeds to step S332 to return an acceptance message; otherwise, the process proceeds to step S333 to return a rejection message.

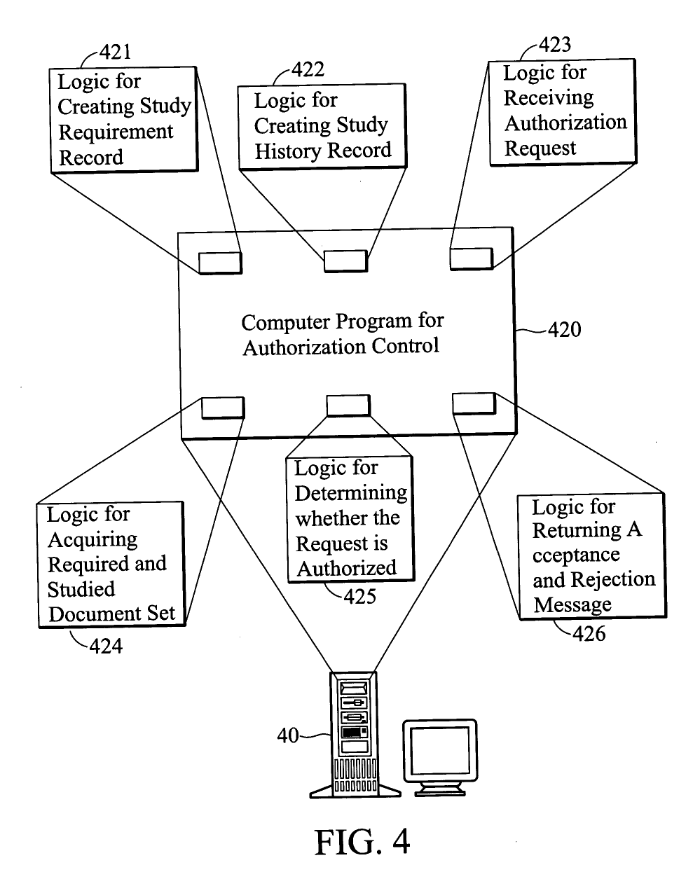

The invention additionally discloses a storage medium for storing a computer program providing the disclosed method of an authorization control, as shown in FIG. 4. The computer program product includes a storage medium 40 having computer readable program code embodied in the medium for use in a computer system, the computer readable program code comprising at least computer readable program code 421 for creating study requirement records via a GUI, computer readable program code 422 for creating study history records via a GUI, computer readable program code 423 for receiving an authorization request with a check item identity and a operator identity, computer readable program code 424 for acquiring a required document set corresponding to the check item identity from the study requirement records and a studied document set corresponding to the operator identity from the study history records, computer readable program code 425 for determining whether the request is authorized by comparing the required document set and the studied document set, and computer readable program code 626 for returning an acceptance message or a rejection message.

The methods and system of the present invention, or certain aspects or portions thereof, may take the form of program code (i.e., instructions) embodied in tangible media, such as floppy diskettes, CD-ROMS, hard drives, or any other machine-readable storage medium, wherein, when the program code is loaded into and executed by a machine, such as a computer, the machine becomes an apparatus for practicing the invention. The methods and apparatus of the present invention may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the invention. When implemented on a general-purpose processor, the program code combines with the processor to provide a unique apparatus that operates analogously to specific logic circuits.

Although the present invention has been described in its preferred embodiments, it is not intended to limit the invention to the precise embodiments disclosed herein. Those who are skilled in this technology can still make various alterations and modifications without departing from the scope and spirit of this invention. Therefore, the scope of the present invention shall be defined and protected by the following claims and their equivalents.

1. A system of authorization control, comprising:
an authorization control apparatus comprising a storage device and an authorization module, such that the storage device is capable of storing a plurality of study requirement records and a plurality of study history records, each study requirement record comprising a check item identity (ID) and a first document ID, each study history record comprising an operator ID and a second document ID, the authorization module receiving an authorization request with the check item ID and the operator ID, acquiring a first document ID set corresponding to the check item ID by querying the study requirement records, acquiring a second document ID set corresponding to the operator ID by querying the study history records, and returning a rejection message when the first document ID set is not subset of the second document ID set.

2. The system of claim 1 wherein the authorization module further returns an acceptance message when the first document ID set is a subset of the second document ID set.

3. The system of claim 1 wherein the authorization control apparatus comprises a requirement configuration module providing a graphical user interface (GUI) to manipulate the study requirement records.

4. The system of claim 3 wherein the authorization control apparatus comprises a study history creation module inserting a new study history record when detecting that a document has been read by an operator.

5. The system of claim 3 wherein the authorization control apparatus comprises a study history creation module inserting a new study history record when an exam corresponding to the second document ID is passed by an operator.

6. The system of claim 1, wherein the check item ID comprises a tool ID, the system further comprising a computer integrated manufacturing (CIM) system issuing the authorization request with the operator ID and the check item ID after receiving an operation request with the operator ID and the tool ID, and displaying an authorization fail message when receiving the rejection message.

7. The system of claim 2, wherein the check item ID comprises a tool ID, the system further comprising a computer integrated manufacturing (CIM) system issuing the authorization request with the operator ID and the check item ID after receiving an operation request with the operator ID, tool ID and relevant recipes, the CIM system issuing an operation command with relevant recipes to a fabrication tool after receiving the acceptance message, and displaying an authorization fail message when receiving the rejection message.

8. The system of claim 1, wherein the check item ID comprises a function ID, the system further comprising a computer integrated manufacturing (CIM) system issuing the authorization request with the operator ID and the check item ID after receiving an execution command with the operator ID and the function ID, and displaying an authorization fail message when receiving the rejection message.

9. The system of claim 2, wherein the check item ID comprises a function ID, the system further comprising a computer integrated manufacturing (CIM) system issuing the authorization request with the operator ID and the check item ID after receiving a CIM execution command with the operator ID, the function ID and parameter values, the CIM system executing a CIM function corresponding to the function ID and parameter values when receiving the acceptance message, and displaying an authorization fail message when receiving the rejection message.

10. The system of claim 1, wherein the check item ID comprises an entrance ID, the system further comprising an entrance control system issuing the authorization request with the operator ID and the check item ID after receiving an entrance request with the operator ID, and sounding an authorization fail alarm when receiving the rejection message.

11. The system of claim 2, wherein the check item ID comprises an entrance ID, the system further comprising a entrance control system issuing the authorization request with the operator ID and the check item ID after receiving an entrance request with the operator ID, opening a door when receiving the acceptance message, and sounding an authorization fail alarm when receiving the rejection message.

12. A method of authorization control, the method comprising using a computer to perform the steps of:
receiving an authorization request with a check item identity (ID) and an operator ID;
acquiring a first document ID set corresponding to the check item ID by querying a plurality of study requirement records, the study requirement record comprising the check item ID and a first document ID;
acquiring a second document ID set corresponding to the operator ID by querying a plurality of study history records, the study history record comprising the operator ID and a second document ID; and
returning a rejection message when the first document ID set is not subset of the second document ID set.

13. The method of claim 12 further comprising a step of returning an acceptance message when the first document ID set is a subset of the second document ID set.

14. The method of claim 12 further comprising a step of inserting a new study requirement record.

15. The method of claim 12 further comprising a step of inserting a new study history record when detecting a document has been read by operator.

16. The method of claim 12 further comprising a step of inserting a new study history record when an exam corresponding to the second document ID is passed by an operator.

17. The method of claim 12, wherein the check item ID comprises a tool ID, the method further comprising the steps of:
issuing the authorization request with the operator ID and the check item ID after receiving an operation request with the operator ID and the tool ID; and
displaying an authorization fail message when receiving the rejection message.

18. The method of claim 13, wherein the check item ID comprises a tool ID, the method further comprising the steps of:
issuing the authorization request with the operator ID and the check item ID after receiving an operation request with the operator ID, tool ID and relevant recipes;
issuing an operation command with relevant recipes to a fabrication tool after receiving the acceptance message; and
displaying an authorization fail message when receiving the rejection message.

19. The method of claim 12, wherein the check item ID comprises a function ID, the method further comprising the steps of:
issuing the authorization request with the operator ID and the check item ID after receiving an execution command with the operator ID and the function ID; and
displaying an authorization fail message when receiving the rejection message.

20. The method of claim 13, wherein the check item ID comprises a function ID, the method further comprising the steps of:
issuing the authorization request with the operator ID and the check item ID after receiving a CIM execution command with the operator ID, the function ID and parameter values;
executing a CIM function corresponding to the function ID and parameter values when receiving the acceptance message; and
displaying an authorization fail message when receiving the rejection message.

21. The method of claim 12, wherein the check item ID comprises an entrance ID, the method further comprising the steps of:
issuing the authorization request with the operator ID and the check item ID after receiving an entrance request with the operator ID; and
sounding an authorization fail alarm when receiving the rejection message.

22. The method of claim 13, wherein the check item ID comprises a tool ID, the method further comprising the steps of:
issuing the authorization request with the operator ID and the check item ID after receiving an entrance request with the operator ID;
opening a door when receiving the acceptance message; and
sounding an authorization fail alarm when receiving the rejection message.
